(19) United States
(12) Patent Application Publication
(10) Pub. No.: US 2007/0264894 A1
(43) Pub. Date: Nov. 15, 2007

(54) All Purpose Gloves

(76) Inventor: Meir Lerner, Brooklyn, NY (US)

Correspondence Address: Meir LERNER, 525 Kent Ave, Brooklyn, NY, 11211, US

(21) Appl. No.: 11/746,624

(22) Filed: May 9, 2007

Related U.S. Application Data
(60) Provisional application No. 60/746,985, filed on May 10, 2006.

(51) Int. Cl. D04H 1/00; D02G 3/00; B32B 5/16; B32B 27/12; A01K 1/015; B32B 5/26; B32B 5/24

(52) U.S. Cl. 442/268; 442/381; 442/394; 442/370; 428/221

(57) ABSTRACT

A handwear (gloves or mittens) is provided for cleaning, washing, dishwashing, medical treatments, handy works, gardening, construction, etc., comprising: a flexible under-layer placeable over the hand, an over-layer placeable over the under-layer, and attachment means joining the layers. The over-layer comprises functional preferably disposable fragments situated in a finger, palm, or thumb sections thereof. In other embodiments flexible cover-shells are placed over the under-layer. The over-layer or cover-shells are made of at least one: steelwool, sponges, double pads, soap pads, rags, wiping materials, materials including medical ointments, creams, oils, glue, lubrications, special pastes, and polish. The attachment means are provided in one of the forms: Velcro™ strips, mechanical fastening, magnetic fastening, gluing, stitching, adhesive bonding, chemical bonding, weaving, fusion, thermal welding, and ultrasound welding, plastic sealing band. Some embodiments' under-layers are furnished with pockets, the fragments are made insertable into and removable from the pockets. Some pockets enclose soap-filled bags.

### CROSS REFERENCE TO RELATED APPLICATIONS

This patent application claims the benefit a U.S. provisional patent application Ser. No. 60/746,985 filed on May 10, 2007 the disclosure of which is incorporated herein in its entirety by reference. This patent application also contains a new portion not disclosed in the above provisional application.

### TECHNICAL FIELD

The present invention relates to work and household gloves or mittens (herein also called handwear), particularly to disposable and non-disposable gloves or mittens usable for cleaning, washing, dishwashing, medical purposes, handy works, and also for gardening, construction, and a variety of other works.

### BACKGROUND OF THE INVENTION

Disposable and non-disposable gloves or mittens are widely known in the prior art. Some of prior art patents and publications describe rubber gloves with abrasive surface, scrubbers, powder-dispenser means, net assemblies, etc.

For example, U.S. Pat. No. 6,460,190 teaches “A cleaning mitten including a mitten portion including a finger and palm section and a thumb section. The mitten further includes a front surface and a back surface. The mitten portion has an open lower end for receiving a hand therein. A sponge surface is disposed on the front surface and the back surface of the finger and palm section of the mitten portion. A nylon netting is disposed over the sponge surface. A rigid scraper extends outwardly of the thumb section of the mitten portion.”

### BRIEF DESCRIPTION OF THE INVENTION

The above described prior art handwear items are designed mainly for cleaning and scrubbing purposes and essentially don't provide a necessary usage flexibility and disposable features. Therefore, aims of the present invention are to particularly provide disposable and non-disposable gloves and mittens for dishwashing, other types of washing, diapering, medical usage, for handyman works, gardening, construction, etc. to protect hands from outside substances like water, glue, soap, dust, and so on.

Other aims of the invention will become apparent from a consideration of the drawings, ensuing description, and claims as hereinafter related.

According to the mentioned aims, different materials can be utilized in various embodiments of the inventive handwear. The basic gloves or mittens layer (herein called an under-layer to be put on the hand) is mostly made of vinyl, or material with similar properties (though other natural and artificial fabrics can be utilized). Sometimes, regular disposable rubber gloves can be used as the under-layer. In some embodiments, functional fragments of the gloves or mittens are preferably made as an additional layer (an over-layer placed over the under-layer) of various materials depending on the purpose of the over-layer. The fragments may be suitably attached to different parts of the handwear.

For instance, for dishwasher purposes: steelwool, sponges, double pads, soap pads, etc. may be used to make the fragments. For other washing purposes: any kind of rags can be deployed. For diapering handwear: the use of wiping materials can be recommended. For medical purposes: the handwear may be furnished with medical ointments, creams, special oils and similar materials. For handy handwear: glue, lubrications, special pastes, polish creams, and the like can be applied.

In certain embodiments, a thin film piece can initially cover the over-layer, which piece then can be removed immediately prior to performing the work, so that the functional layer (e.g. a cosmetic cream, an auto-polish, etc.) will be fresh and readily available on the over-layer.

In other embodiments, the under-layer can include sponges, etc. For instance, the over-layer is made of steelwool, the under-layer is made of sponge, and the over-layer is fastened to the under-layer by a Velcro™ strip, so that the soft lower Velcro part is attached to the under-layer, and the rough Velcro part is attached to the over-layer. Thusly, after scrubbing the dishes, the over-layer can be disposed of by detaching the Velcro rough part, but the lower soft part will remain on the under-layer. Thereafter, a new over-layer having a similar over-layer with the rough Velcro part can be put on the under-layer and attached to its soft Velcro part remaining on the hand to perform the same or another type of work, etc. In another case, the under-layer is used with the sponge (e.g. for rinsing) without an over-layer.

The above-mentioned materials can be arranged for making the over-layer and the under-layer of the gloves or mittens, or for making specially featured flexible cover-shells placeable over the gloves or mittens on the fingers sections (front—inner side of the hand, and back—outer side of the hand), on the palm sections (inner and outer), on the thumb sections (inner and outer). The flexible cover-shell may itself comprise one or more layers. For example: it may be made of vinyl (lower layer) and a soft wiping material (upper layer) adhesively bonded or glued to the vinyl layer. This could safe time and efforts of putting new gloves on for a dentist or a doctor treating a patient, and so on.

In some embodiments, special functional fragments of necessary sizes can be inserted (or imposed) into (or upon) the gloves' or mittens' under-layer material and attached to it (e.g. stitched, glued, etc.); or parts of the gloves or mittens may be fabricated from those materials and then assembled (e.g. stitched, glued, etc.) in one article. The functional fragments can be made of a suitable material necessary to perform the intended function.

In other embodiments the under-layer may comprise specially arranged pockets (having a closed margin portion and an open cut-off portion—not shown herein), so that the fragments can be attached to the under-layer by simply inserting them into the pockets, wherein a margin portion of the fragment is situated under the closed margin portion of the pocket, and the functional surface of the fragment is situated in the open portion of the pocket. The fragments can be attached to the margin portion by various conventionally known means. After it has been worn out, it can be removed and replaced by a similar fragment inserted into the pocket.

Some embodiments may comprise aforesaid pockets between the over-layer and under-layer with small orifices on the over-layer. The pockets include sealed liquid soap bags inserted therein. A removable sealing film may be placed over the orifices and coupled to the bag's spots located under the orifices. When the film is removed and the bag's spots are torn off, the soap will come out of the pocket.

Similarly, soap-filled bubbles can be sealed and coupled to the over-layer. The person wearing the handwear may press the bubbles and squeeze the soap out of them, for instance, to wash dishes, and then rinse the soap out.

In different embodiments the under-layer, over-layer, cover-shell, functional fragments of the over-layer or cover-shell can be made disposable or non-disposable in any combination thereof, depending on the purpose of the handwear article.

Since the mentioned cover-shells and fragments may be of comparatively small sizes, they can be inexpensively produced from leftover pieces of the aforesaid materials, that is the final product (gloves or mittens) will also have a low price acceptable for many consumers.

Of course, other methods of attachments can be employed where necessary, including: mechanical or magnetic fastening, weaving, chemical or adhesive bonding, thermal welding, ultrasonic welding, fusion, etc.

### DESCRIPTION OF THE DRAWINGS

The mentioned and/or other aspects and advantages of the present inventive concept will become apparent and more readily appreciated from the following description of exemplary embodiments, taken in conjunction with the accompanying drawings of which:

FIG. 1A is a perspective view of the outer side of a right glove with a cover-shell, according to an embodiment of the present invention.

FIG. 1B is a perspective view of the outer side of a left glove with a cover-shell, according to an embodiment of the present invention.

FIG. 2A is a perspective view of the outer side of a right mitten with a cover-shell, according to an embodiment of the present invention.

FIG. 2B is a perspective view of the outer side of a left mitten with a cover-shell, according to an embodiment of the present invention.

FIG. 3A is a perspective view of the inner side of a right glove, according to an embodiment of the present invention.

FIG. 3B is a perspective view of the outer side of a right glove, according to an embodiment of the present invention.

FIG. 4A is a perspective view of the inner side of a right mitten, according to an embodiment of the present invention.

FIG. 4B is a perspective view of the outer side of a right mitten, according to an embodiment of the present invention.

Similar reference numerals on the drawings generally refer to the same or similar elements on different figures. A newly introduced numeral in the description is enclosed into parentheses.

### DESCRIPTION OF EXAMPLE PREFERRED EMBODIMENTS

While the invention may be susceptible to embodiment in different forms, there are shown in the drawings, and will be described in detail herein, three specific embodiments of the present invention, with the understanding that the present disclosure is to be considered an exemplification of the principles of the invention, and is not intended to limit the invention to that as illustrated and described herein.

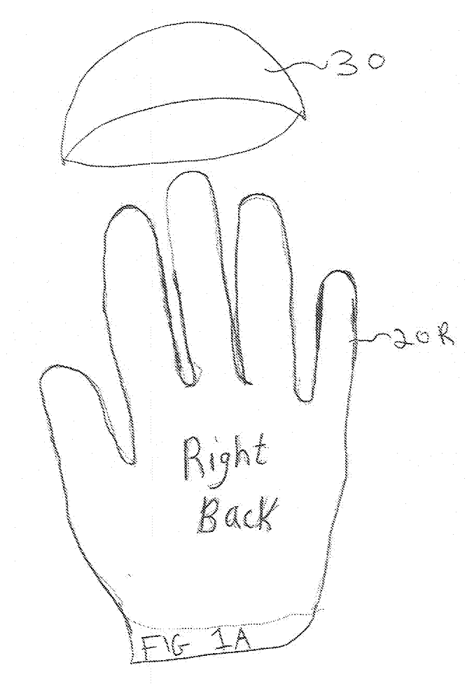

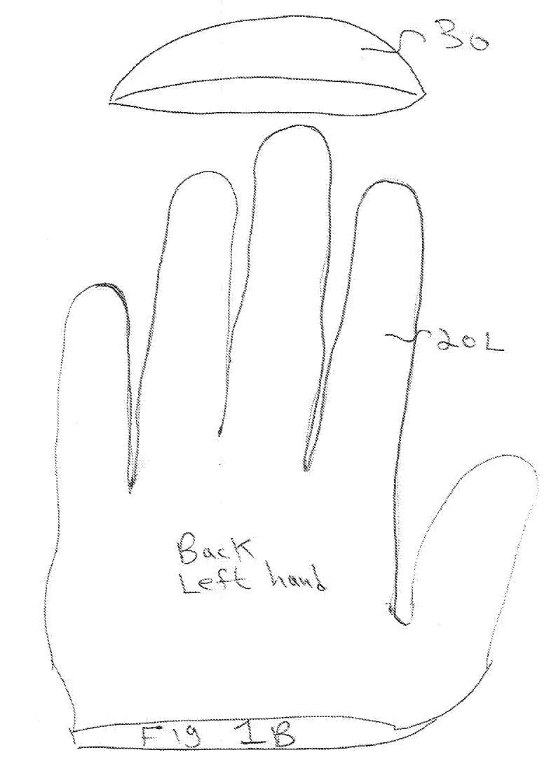

A first sample embodiment of the invention is illustrated on FIGS. 1A and 1B, wherein a one layer glove having an outer layer for the right hand (20R) and for the left hand (20L) are shown. An exemplary cover-shell (30) is depicted in the figures. As mentioned above, the cover-shell can be made of a suitable flexible material and coated with a functional layer (e.g. scraping or wiping material). The cover-shell can also be placed on the palm or thumb section of the gloves (not shown), if it facilitates performing an operation with this part of hand.

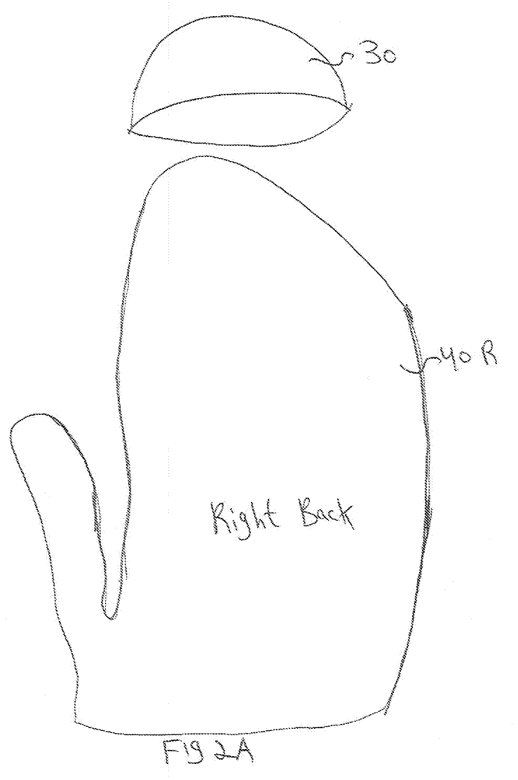

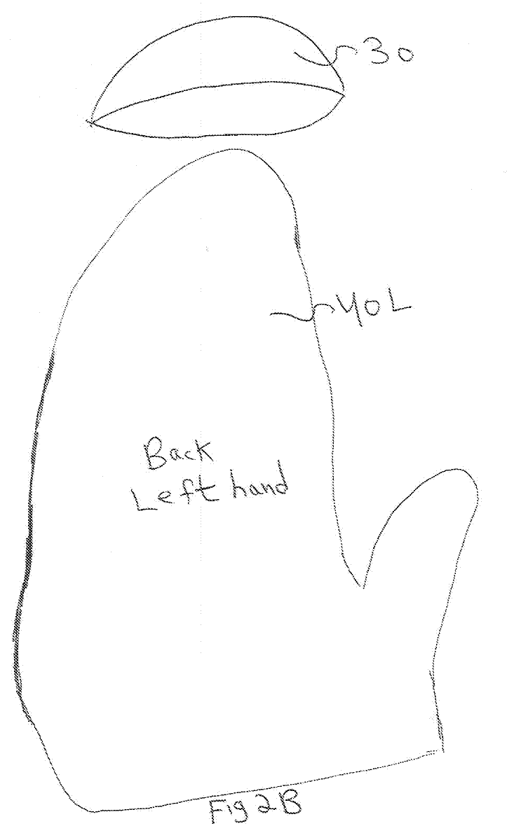

Similar features are illustrated on FIGS. 2A and 2B for mittens (40R) and (40L) respectively for the right and the left hand (a second sample embodiment), and the cover-shell 30 placeable over them.

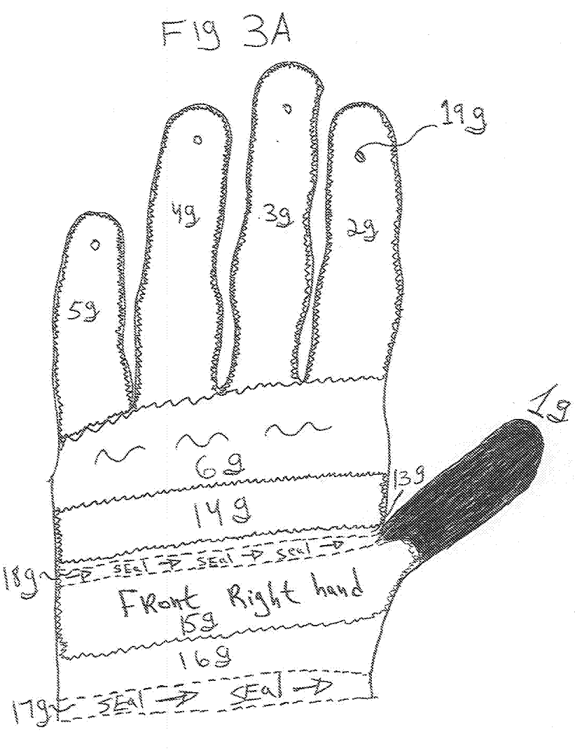

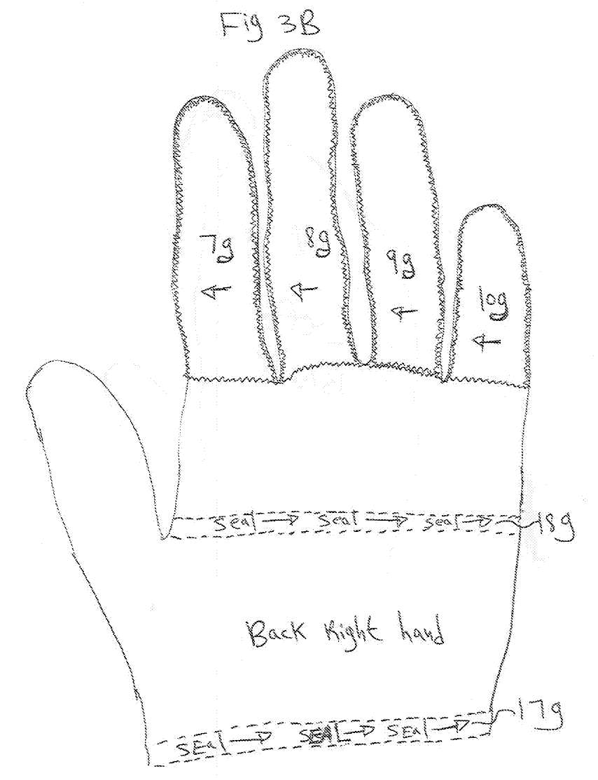

A third sample embodiment of the invention is illustrated on FIGS. 3A, 3B. The inner portion of the thumb section (FIG. 3A) of a right glove is referred to as (1g) that can be covered, for instance, by sandpaper, or another scrubbing material. The corresponding inner finger portions of the under-layer are referred to as (2g), (3g), (4g), and (5g). The finger portions can be covered by aforementioned cover-shells. A portion (6g) of the glove's under-layer remains uncovered to facilitate operation of the hand.

Functional fragments (14g) and (15g) can, for example, carry a special lubrication paste, so that after a first operation performed by fingers (e.g. assembling of parts) is finished, a second operation can be lubrication of the parts carried out by the fragments 14g and 15g. A portion (16g) of the glove's under-layer remains uncovered to facilitate operation of the hand. Sealed plastic bands (17g) and (18g) can be provided to secure fragments on the under-layer, or to secure the over-layer on the under-layer.

A portion (13g) is a stitch joining two ends of the sealing plastic band 18g. It can be joined thermally or by another suitable method. When the over-layer or a fragment is worn out, the plastic band 17g or 18g can be torn away, and the over-layer or the fragment may be replaced with another over-layer or fragment. Similar sealing bands can be placed in other parts of the gloves.

FIG. 3B illustrates the outer side of the glove with respective finger portions (7g), (8g), (9g), and (10g). It also shows the plastic band 18g.

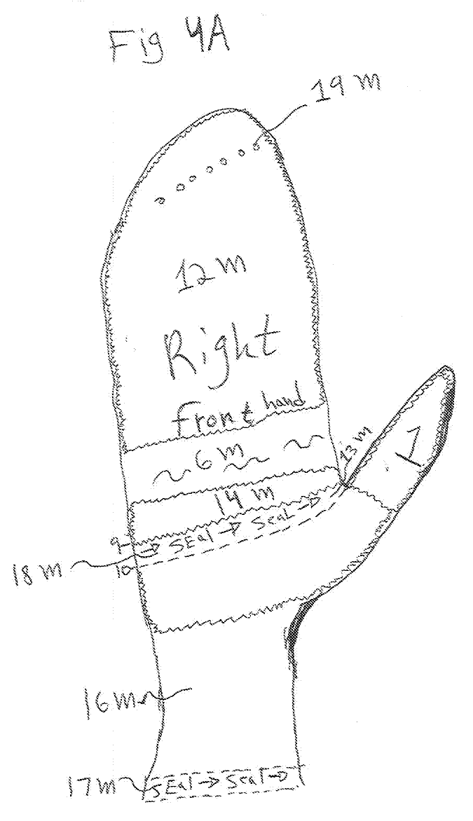

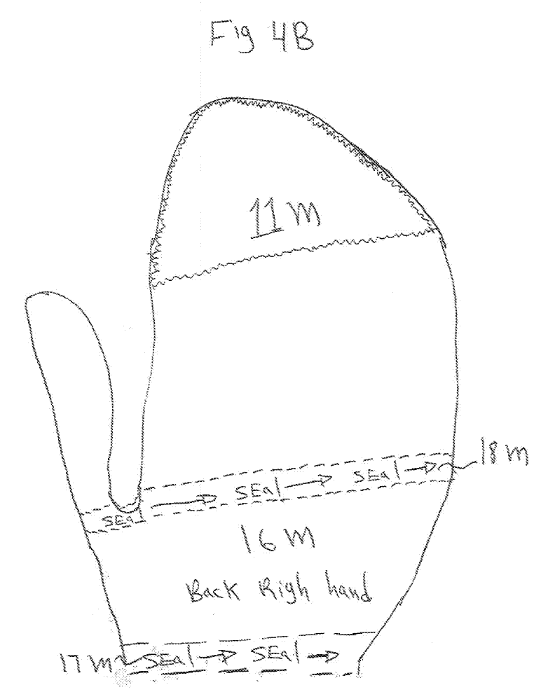

A fourth sample embodiment of the invention is illustrated on FIGS. 4A, 4B. FIG. 4A depicts a right hand mitten (inner portion) having an under-layer and an over-layer comprising an inner thumb portion (1m), an inner finger portion (12m), functional fragments (14m) and (15m), sealing bands (17m) and (18m). A portion (13m) is a stitch joining two ends of the sealing plastic band 18m. Uncovered portions (6m) and (16m) of the under-layer are also shown. The fragments may have similar or different purposes comparatively to the corresponding fragments of the third sample embodiments for gloves. FIG. 4B additionally shows an outer finger portion (11m) of the over-layer.

The third and fourth embodiments comprise pockets between the over-layer and under-layer with small orifices (19g) and (19m) made in the over-layer, shown on FIGS. 3A and 4A. The pockets enclose sealed liquid soap bags inserted therein. A removable sealing film (not shown) may be placed over the orifices and coupled (e.g. soldered) to the bag's spots located under the orifices. When the film is removed and the bag's spots are torn off, the soap will come out of the pocket to provide better cleaning. Instead of the soap, other detergents can be used for different cleaning purposes.

Similarly, soap-filled bubbles (not shown herein) can be sealed and attached (e.g. glued) to the over-layer of the gloves or mittens. The person wearing the handwear may press the bubbles and squeeze the soap out of them, for instance, to wash dishes, and then rinse the soap out.

Those skilled in the art will appreciate that the conception, upon which this disclosure is based, may readily be utilized as a basis for the designing of other structures and methods for carrying out several purposes of the present invention. It is therefore important that the claims be regarded as including such equivalent constructions insofar as they do not depart from the spirit and scope of the present invention. As opposed to the claims, the foregoing abstract is neither intended to define the invention of the instant application, which is measured by the claims, nor is it intended to be limiting as to the scope of the invention in any way.

I claim:

1. A handwear article for performing at least one function of cleaning, washing, dishwashing, medical treatments, handy works, gardening, construction and the like, comprising:
a flexible under-layer placeable on the hand,
a flexible over-layer including at least one functional fragment fabricated of a material suitable for carrying out said at least one function, said over-layer placeable over the under-layer, and
attachment means for joining the under-layer and the over-layer.

2. The handwear article according to claim 1, wherein said under-layer furnished with sponges.

3. The handwear article according to claim 1, wherein
said over-layer covered by a thin film removable before using the handwear.

4. The handwear article according to claim 1, wherein said material comprising at least one of the following:
steelwool, sponges, double pads, soap pads, rags, wiping materials, materials including medical ointments, creams, oils, glue, lubrications, special pastes, and polish.

5. The handwear article according to claim 1, wherein said attachment means comprising at least one of the following:
Velcro™ strips, mechanical fastening, magnetic fastening, gluing, stitching, adhesive bonding, chemical bonding, weaving, fusion, thermal welding, and ultrasound welding.

6. The handwear article according to claim 1, wherein said attachment means comprising
a stitched plastic sealing band.

7. The handwear article according to claim 1, wherein
said under-layer furnished with a number of pockets, and
said at least one functional fragment made insertable into and removable from the pockets.

8. The handwear article according to claim 1, further comprising:
a number of pockets with orifices, said pockets arranged between the under-layer and the over-layer and enclosing sealed bags filled with liquid soap or detergent inserted in the pockets, and
a removable sealing film placed over the orifices and coupled to the bag's spots located under the orifices.

9. The handwear article according to claim 1, wherein
said over-layer furnished with a number of sealed soap-filled bubbles coupled to the over-layer.

10. The handwear article according to claim 1, wherein
both or at least one of said under-layer and said over-layer made disposable.

11. A handwear article for performing at least one function of cleaning, washing, dishwashing, medical treatments, handy works, gardening, construction and the like, said article including a finger section, a thumb section, and a palm section, said article comprising
a flexible under-layer placeable on the hand,
at least one flexible cover-shell fabricated of at least one layer of a material suitable for carrying out said at least one function, said cover-shell being placeable over the under-layer on at least one of the finger section, the thumb section, and the palm section, and
attachment means joining the under-layer and said at least one cover-shell.

12. The handwear article according to claim 9, wherein said material comprising at least one of the following:
steelwool, sponges, double pads, soap pads, rags, wiping materials, materials including medical ointments, creams, oils, glue, lubrications, special pastes, and polish.

13. The handwear article according to claim 9, wherein said attachment means comprising at least one of the following:
Velcro™ strips, mechanical fastening, magnetic fastening, gluing, stitching, adhesive bonding, chemical bonding, weaving, fusion, thermal welding, and ultrasound welding.

14. The handwear article according to claim 9, wherein
both or at least one of said under-layer and said cover-shell made disposable.
